(19) United States
(12) Patent Application Publication
(10) Pub. No.: US 2026/0213217 A1
(43) Pub. Date: Jul. 23, 2026

(54) COMPOSITE CURRENT COLLECTOR, PREPARATION METHOD THEREFOR, ELECTRODE, AND SECONDARY BATTERY

(71) Applicant: Jiangyin Nanopore Innovative Materials Technology Ltd, Wuxi, Jiangsu (CN)

(72) Inventors: Zhongya Zhu, Wuxi, Jiangsu (CN); Shuai Wang, Wuxi, Jiangsu (CN); Jianzhong Xia, Wuxi, Jiangsu (CN); Xuefa Li, Wuxi, Jiangsu (CN); Guoping Zhang, Wuxi, Jiangsu (CN)

(73) Assignee: Jiangyin Nanopore Innovative Materials Technology Ltd, Wuxi, Jiangsu (CN)

(21) Appl. No.: 19/143,150

(22) PCT Filed: Dec. 28, 2023
(86) PCT No.: PCT/CN2023/142577

§ 371 Date: Jun. 25, 2025

(30) Foreign Application Priority Data
Dec. 29, 2022 (CN) 202211705240.2
Dec. 29, 2022 (WO) PCT/CN2022/143309

(51) Int. Cl. H01M 4/66; H01M 4/04

(52) U.S. Cl. CPC H01M 4/668; H01M 4/0404; H01M 4/661; H01M 4/667

(57) ABSTRACT

A composite current collector, a preparation method therefor, an electrode, and a secondary battery. The composite current collector comprises: a polymer base film and composite layers provided on two sides of the polymer base film. Each composite layer comprises: a modified layer arranged on the polymer base film, and a metal layer arranged on the surface of the modified layer, wherein the material of the modified layer is a polymer formed by in-situ graft polymerization of a polymerized monomer and/or oligomer on the surface of the polymer base film; and the polymerized monomer comprises an acrylamide monomer, a crotonic acid monomer, or a combination thereof.

### TECHNICAL FIELD

The present application relates to the field of electrochemistry and, in particular, to a composite current collector, a preparation method therefor, an electrode, and a secondary battery.

### BACKGROUND

Currently, composite current collectors based on polymer films have attracted widespread attention in the new energy industry and have been widely applied as well. The preparation process of these composite current collectors generally involves depositing a metal layer (for example, aluminum or copper) onto a polymer film (such as polypropylene, polyethylene or polyester) using physical vapor deposition (PVD) techniques. The resulting surface-metalized film with conductive properties constitutes the composite current collector. Compared with conventional current collectors, the composite current collectors based on polymer films offer advantageous characteristics including lower costs, lighter weight, and superior internal insulation properties. These characteristics make the composite current collectors capable of reducing battery manufacturing costs while enhancing energy density and safety when these composite current collectors are applied to batteries.

The weak surface polarity of polymer films typically results in low surface tension and poor adhesion properties of the surface of the composite current collectors, and then the bonding between the polymer base film and the metal layer in the prepared composite current collectors becomes weak, ultimately leading to poor structural stability of the composite current collectors and hindering the practical application of the composite current collectors. Therefore, there is a pressing need to develop a structurally stable composite current collector to enhance the structural stability of the existing composite current collectors and facilitate their broader adoption and application.

### SUMMARY

The following is a summary of the subject matter described in detail herein. This summary is not intended to limit the scope of the claims.

In view of the above, the present application provides a composite current collector, a preparation method therefor, an electrode, and a secondary battery to improve the bonding between a polymer base film and a metal layer and enhance the structural stability of a composite current collector.

A first aspect of the present application provides a composite current collector. The composite current collector comprises a polymer base film and composite layers arranged on two sides of the polymer base film. Each composite layer comprises:
a modified layer arranged on the polymer base film and a metal layer arranged on the surface of the modified layer, wherein a material of the modified layer comprises a polymer formed by in-situ graft polymerization of a polymerization monomer and/or an oligomer on the surface of the polymer base film, the polymerization monomer comprises an acrylamide monomer, a crotonic acid monomer or a combination thereof, and the oligomer comprises an acrylamide oligomer, a crotonic acid oligomer or a combination thereof;
the acrylamide monomer has a structure represented by Formula I-1:

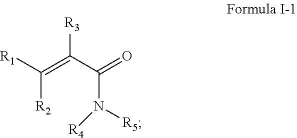

in Formula I-1, R₁ and R₂ are each independently hydrogen, fluorine, chlorine, or bromine; R₃ is hydrogen, methyl, hydroxymethyl, ethyl, hydroxyethyl, fluorine, chlorine, or bromine; R₄ and R₅ are each independently hydrogen, alkyl having 1 to 5 carbon atoms, phenyl, or acrylamido;
the acrylamide oligomer has a structure represented by Formula I-2:

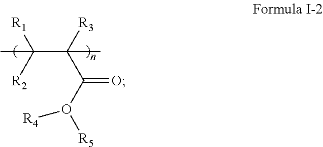

in Formula I-2, R₁ and R₂ are each independently hydrogen, fluorine, chlorine, or bromine; R₃ is hydrogen, methyl, hydroxymethyl, ethyl, hydroxyethyl, fluorine, chlorine, or bromine; R₄ and R₅ are each independently hydrogen, alkyl having 1 to 5 carbon atoms, phenyl, or acrylamido; n represents an integer from 2 to 10;
the crotonic acid monomer has a structure represented by Formula II-1:

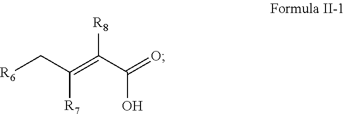

in Formula II-1, R₆ is hydrogen, hydroxyl, fluorine, chlorine, or bromine; R₇ and R₅ are each independently hydrogen, methyl, hydroxymethyl, fluorine, chlorine, or bromine;
the crotonic acid oligomer has a structure represented by Formula II-2:

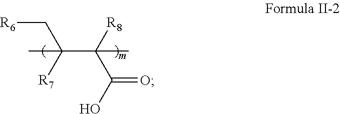

in Formula II-2, R₆ is hydrogen, hydroxyl, fluorine, chlorine, or bromine; R₇ and R₅ are each independently hydrogen, methyl, hydroxymethyl, fluorine, chlorine, or bromine; m represents an integer from 2 to 10.

In some embodiments of the present application, the modified layer meets at least one of conditions (1) to (14) as follows:
(1) The polymer of the modified layer comprises a homopolymer of the crotonic acid monomer;
in some embodiments, the polymer is selected from polycrotonic acid, poly(4-hydroxycrotonic acid), poly(2-hydroxymethylcrotonic acid), poly(2,3-dihydroxymethylcrotonic acid), poly(3-chlorocrotonic acid), poly(3-chloro-4-hydroxycrotonic acid), poly(3,4-dichlorocrotonic acid), poly(2,3-dichloro-4-hydroxycrotonic acid), poly(2,3,4-trichlorocrotonic acid), poly(4-bromocrotonic acid), poly(4-fluorocrotonic acid), and combinations thereof.
(2) The polymer of the modified layer comprises a homopolymer of the acrylamide monomer;
in some embodiments, the polymer is selected from polyacrylamide, polymethacrylamide, poly(N,N-methylenebisacrylamide), poly(N,N-dimethylacrylamide), poly(N-isopropylacrylamide), poly(N-tert-butylacrylamide), poly(N-phenylacrylamide), poly(2-chloro-acrylamide), poly(2-hydroxymethyl-acrylamide), poly(3-bromo-acrylamide), poly(2-hydroxymethyl-3-bromo-acrylamide), and combinations thereof.
(3) The polymer of the modified layer comprises a polyacrylamide-polyacrylamide copolymer formed from different acrylamide monomers.
(4) The polymer of the modified layer comprises a polycrotonic acid-polycrotonic acid copolymer formed from different crotonic acid monomers.
(5) The polymer of the modified layer comprises a polycrotonic acid-polyacrylamide copolymer formed from the polyacrylamide monomer and the crotonic acid monomer.
(6) The polymer of the modified layer comprises a homopolymer of the crotonic acid oligomer;
optionally, the polymer is selected from polycrotonic acid, poly(4-hydroxycrotonic acid), poly(2-hydroxymethylcrotonic acid), poly(2,3-dihydroxymethylcrotonic acid), poly(3-chlorocrotonic acid), poly(3-chloro-4-hydroxycrotonic acid), poly(3,4-dichlorocrotonic acid), poly(2,3-dichloro-4-hydroxycrotonic acid), poly(2,3,4-trichlorocrotonic acid), poly(4-bromocrotonic acid), poly(4-fluorocrotonic acid), and combinations thereof.
(7) The polymer of the modified layer comprises a homopolymer of the acrylamide oligomer;
optionally, the polymer is selected from polyacrylamide, polymethacrylamide, poly(N,N-methylenebisacrylamide), poly(N,N-dimethylacrylamide), poly(N-isopropylacrylamide), poly(N-tert-butylacrylamide), poly(N-phenylacrylamide), poly(2-chloro-acrylamide), poly(2-hydroxymethyl-acrylamide), poly(3-bromo-acrylamide), poly(2-hydroxymethyl-3-bromo-acrylamide), and combinations thereof.
(8) The polymer of the modified layer comprises a polyacrylamide-polyacrylamide copolymer formed from different acrylamide oligomers.
(9) The polymer of the modified layer comprises a polycrotonic acid-polycrotonic acid copolymer formed from different crotonic acid oligomers.
(10) The polymer of the modified layer comprises a polycrotonic acid-polyacrylamide copolymer formed from the acrylamide oligomer and the crotonic acid oligomer.
(11) The polymer of the modified layer comprises a polyacrylamide-polyacrylamide copolymer formed from different polyacrylamide monomers and acrylamide oligomers.
(12) The polymer of the modified layer comprises a polycrotonic acid-polycrotonic acid copolymer formed from different crotonic acid monomers and crotonic acid oligomers.
(13) The polymer of the modified layer comprises a polycrotonic acid-polyacrylamide copolymer formed from the acrylamide oligomer and the crotonic acid monomer.
(14) The polymer of the modified layer comprises a polycrotonic acid-polyacrylamide copolymer formed from the acrylamide monomer and the crotonic acid oligomer.

In some embodiments of the present application, the composite current collector meets at least one of conditions (1) to (3).
(1) The modified layer has a thickness of 20 nm to 100 nm.
(2) The polymer base film has a thickness of 2 μm to 20 μm;
in some embodiments, a material of the polymer base film comprises polypropylene, polyethylene, polyethylene terephthalate, polybutylene terephthalate, polyethylene naphthalate, polyphenelyne ether, polyvinyl chloride, polyvinylidene fluoride, polystyrene or a combination thereof.
(3) The metal layer has a thickness of 500 nm to 2000 nm;
in some embodiments, a material of the metal layer comprises copper, a copper alloy, aluminum, an aluminum alloy, nickel, a nickel alloy, titanium, silver or a combination thereof.

In some embodiments, the composite layer further comprises a protective layer, wherein the protective layer is arranged on the surface of a side, facing away from the modified layer, of the metal layer.

In some embodiments, the protective layer has a thickness of 10 nm to 150 nm.

In some embodiments, a material of the protective layer comprises nickel, chromium, a nickel-based alloy, a copper-based alloy, copper oxide, aluminum oxide, nickel oxide, chromium oxide, cobalt oxide, graphite, carbon black, acetylene black, ketjen black, a carbon nano/quantum dot, a carbon nanotube, a carbon nanofiber, graphene or a combination thereof.

A second aspect of the present application provides a method for preparing a composite current collector, including the following steps:
performing a light-induced graft polymerization surface modification treatment on the surface of a polymer base film to form a modified layer; and
forming a metal layer on the surface of the modified layer;
wherein the light-induced graft polymerization surface modification treatment comprises: subjecting a polymerization monomer and/or an oligomer to a light-induced graft polymerization reaction in the presence of a photosensitizer to form a polymer; wherein the polymerization monomer comprises an acrylamide monomer, a crotonic acid monomer or a combination thereof; and the oligomer comprises an acrylamide oligomer, a crotonic acid oligomer or a combination thereof.

The acrylamide monomer has a structure represented by Formula I-1:

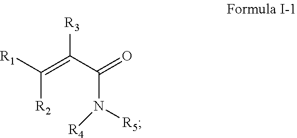

wherein in Formula I-1, R₁ and R₂ are each independently hydrogen, fluorine, chlorine, or bromine; R₃ is hydrogen, methyl, hydroxymethyl, ethyl, hydroxyethyl, fluorine, chlorine, or bromine; R₄ and R₅ are each independently hydrogen, alkyl having 1 to 5 carbon atoms, phenyl, or acrylamido.

The acrylamide monomer has a structure represented by Formula I-2:

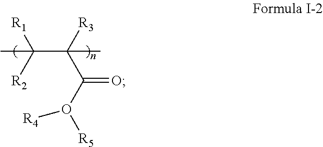

in Formula I-2, R₁ and R₂ are each independently hydrogen, fluorine, chlorine, or bromine; R₃ is hydrogen, methyl, hydroxymethyl, ethyl, hydroxyethyl, fluorine, chlorine, or bromine; R₄ and R₅ are each independently hydrogen, alkyl having 1 to 5 carbon atoms, phenyl, or acrylamido; n represents an integer from 2 to 10.

The crotonic acid monomer has a structure represented by Formula II-1:

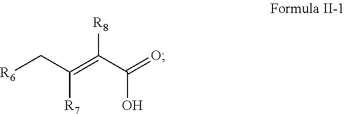

in Formula II-1, R₆ is hydrogen, hydroxyl, fluorine, chlorine, or bromine; R₇ and R₅ are each independently hydrogen, methyl, hydroxymethyl, fluorine, chlorine, or bromine.

The crotonic acid monomer has a structure represented by Formula II-2:

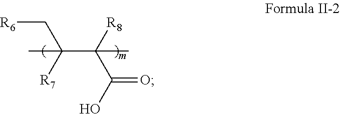

in Formula II-2, R₆ is hydrogen, hydroxyl, fluorine, chlorine, or bromine; R₇ and R₅ are each independently hydrogen, methyl, hydroxymethyl, fluorine, chlorine, or bromine; m represents an integer from 2 to 10.

In some embodiments of the present application, a process of performing the radiation-induced graft polymerization surface modification treatment on the surface of the polymer base film comprises the following steps:

Immersing the polymer base film in a solution containing a photosensitizer, a polymerization monomer and/or an oligomer for pretreatment; and
irradiating the polymer base film immersed in the solution with an ultraviolet lamp in an inert atmosphere to cause a graft polymerization reaction on the surface of the polymer base film under the induction of ultraviolet light to form the modified layer.

In some embodiments of the present application, the preparation method meets at least one of conditions (1) to (3):
(1) the polymerization monomer and/or the oligomer in the solution has a concentration of 0.5 mol/L to 1.3 mol/L;
(2) the photosensitizer in the solution has a concentration of 0.1 mol/L to 0.3 mol/L; and
(3) the photosensitizer comprises a benzophenone photosensitizer.

Optionally, the benzophenone photosensitizer comprises benzophenone, 2,4-dihydroxybenzophenone, Michler's ketone or a combination thereof.

In some embodiments of the present application, the preparation method meets at least one of conditions (1) to (3):
(1) a distance between the ultraviolet lamp and the polymer base film is 10 cm to 30 cm;
(2) the ultraviolet lamp has a power density of 50 W/cm to 250 W/cm; and
(3) the ultraviolet lamp has an irradiation time of 10 seconds to 200 seconds.

In some embodiments of the present application, the preparation method meets at least one of conditions (1) to (8).
(1) The polymerization monomer is selected from one, two or more crotonic acid monomers.
(2) The polymerization monomer is selected from one, two or more acrylamide monomers.
(3) The polymerization monomer comprises the acrylamide monomer and the crotonic acid monomer.
(4) The polymerization monomer is selected from one, two or more crotonic acid oligomers.
(5) The polymerization monomer is selected from one, two or more acrylamide oligomers.
(6) The polymerization monomer comprises at least one acrylamide oligomer and at least one crotonic acid oligomer.
(7) The polymerization monomer comprises at least one acrylamide monomer and at least one crotonic acid oligomer.
(8) The polymerization monomer comprises at least one acrylamide oligomer and at least one crotonic acid monomer.

In some embodiment of the present application, after the modified layer is formed, the preparation method further comprises the following step:

performing a cleaning treatment and a drying treatment on the polymer base film containing the modified layer.

In some embodiments, the cleaning treatment is performed at a temperature of 70° C. to 90° C.

In some embodiments, the cleaning treatment is performed for a period of 5 minutes to 10 minutes.

In some embodiments, the drying treatment is performed at a temperature of 60° C. to 80° C.

In some embodiments, the preparation method further comprises the following step:

forming a protective layer on the surface of a side, facing away from the modified layer, of the metal layer.

Materials of the polymer base film, the metal layer, and the protective layer are as described in the first aspect of the present application, and the details are not repeated herein.

A third aspect of the present application provides a composite current collector prepared by the preparation method described in the second aspect of the present application.

A fourth aspect of the present application provides an electrode. The electrode comprises the composite current collector described in the first aspect of the present application or the composite current collector described in the third aspect of the present application.

A fifth aspect of the present application provides a secondary battery. The secondary battery comprises the electrode described in the fourth aspect of the present application.

The details of one or more embodiments of the present application are set forth in the following drawings and description. Other features, objects, and advantages of the present application will become apparent from the specification, drawings, and claims.

Other aspects can be understood upon reading and understanding the drawings and detailed descriptions.

### BRIEF DESCRIPTION OF DRAWINGS

To illustrate the technical solutions in embodiments of the present application or the technical solutions in the related art more clearly, drawings used in the description of the embodiments or the related art are briefly described hereinafter. Apparently, the drawings described hereinafter are merely embodiments of the present application, and those of ordinary skill in the art may obtain other drawings based on disclosed drawings on the premise that no creative work is done.

The drawings are intended to provide a further understanding of technical solutions herein, constitute part of the specification, explain the technical solutions herein in conjunction with embodiments of the present application, and do not limit the technical solutions herein.

FIG. 1 is a structure view of a composite current collector according to an embodiment of the present application;

FIG. 2 is a structure view of a composite current collector according to another embodiment of the present application;

FIG. 3 is a cross-sectional morphology image of a polypropylene film containing a modified layer on its surface in Example 1 of the present application; and

FIG. 4 is a cross-sectional morphology image of the polypropylene film containing a modified layer on its surface in Example 1 of the present application after undergoing an enhanced surface cleaning treatment.

### DETAILED DESCRIPTION

The technical solutions in embodiments of the present application will be described clearly and completely in conjunction with the drawings in embodiments of the present application. Apparently, the embodiments described hereinafter are part, not all, of embodiments of the present application. Based on the embodiments of the present application, all other embodiments obtained by those of ordinary skill in the art without creative work are within the scope of the present application.

For the sake of simplicity, only some numerical ranges are expressly disclosed herein. However, any lower limit may be combined with any upper limit to form a range not expressly recited; any lower limit may be combined with another lower limit to form a range not expressly recited, and any upper limit may be combined with any other upper limit to form a range not expressly recited. Further, although not expressly recited, each point or an individual numerical value between the endpoints of the range is comprised in the range. Accordingly, each point or an individual numerical value may be combined with any other point or individual numerical value as a lower limit or upper limit or may be combined with another lower limit or upper limit to form a range not expressly recited.

Unless otherwise defined, all technical and scientific terms used herein have the same meanings as those commonly understood by those skilled in the art to which the present application pertains. The terms used in the specification of the present application are only used for describing specific embodiments and are not intended to limit the present application. It is to be noted that, as used herein, the term “and/or” comprises any and all combinations of one or more of the associated listed items, “above” and “below” are inclusive of the referenced number, and “more” in “one or more” means two or more, unless otherwise specified.

Unless otherwise specified, the terms used herein have well-known meanings as commonly understood by those skilled in the art. Unless otherwise specified, the numerical values of the parameters mentioned in the present application can be measured using various measurement methods commonly used in the art (for example, tests can be carried out according to the methods given in the examples of the present application).

A list of items joined by the term “at least one of” or other similar terms can mean any combination of the listed items. For example, if the listed items are A and B, the phrase “at least one of A or B” means A; B; or A and B. For example, if the listed items are A, B and C, the phrase “at least one of A, B or C” means A; B; C; A and B (excluding C); A and C (excluding B); B and C (excluding A); or A, B and C. The item A may contain a single component or multiple components. The item B may contain a single component or multiple components. The item C may contain a single component or multiple components.

The above content of the present application is not intended to describe each disclosed embodiment or every implementation in the present application. The following description more specifically illustrates exemplary embodiments. In various places throughout the present application, guidance is provided by a series of embodiments, which may be used in various combinations. In the various examples, the enumeration is merely a representative group and should not be construed as exhaustive.

During the research process, the inventors found that in the existing conventional composite current collectors, the weak surface polarity of polymer base films used tends to result in low surface tension and poor surface adhesion properties of the polymer base films, and then the bonding between the polymer base film and the metal layer in the prepared composite current collectors becomes weak, ultimately leading to poor structural stability of the composite current collectors.

To solve the above technical problems, from the viewpoint of surface modification of the polymer base film, the inventors proposed to construct a modified layer containing a functional group-rich polymer between the base film and the metal layer to enable covalent bonding between the modified layer and the base film while conferring high polarity to the modified layer, thereby improving the bonding to the metal layer and enhancing the structural stability of the composite current collector.

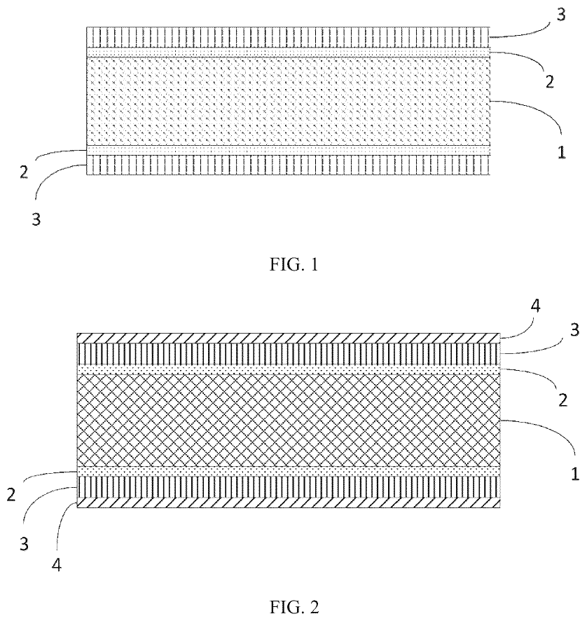

A first aspect of the present application provides a composite current collector. As shown in FIG. 1, the composite current collector comprises a polymer base film 1 and composite layers arranged on two sides of the polymer base film 1. Each composite layer comprises a modified layer 2 arranged on the surface of the polymer base film and a metal layer 3 arranged on the surface of a side, facing away from the polymer base film 1, of the modified layer 2. The material of the modified layer comprises a polymer formed by in-situ graft polymerization of a polymerization monomer and/or an oligomer on the surface of the polymer base film, the polymerization monomer comprises an acrylamide monomer, a crotonic acid monomer or a combination thereof, and the oligomer comprises an acrylamide oligomer, a crotonic acid oligomer or a combination thereof.

The acrylamide monomer has a structure represented by Formula I-1:

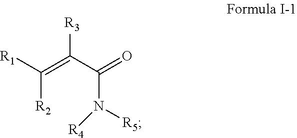

in Formula I-1, R₁ and R₂ are each independently hydrogen, fluorine, chlorine, or bromine; R₃ is hydrogen, methyl, hydroxymethyl, ethyl, hydroxyethyl, fluorine, chlorine, or bromine; R₄ and R₅ are each independently hydrogen, alkyl having 1 to 5 carbon atoms, phenyl, or acrylamido.

The acrylamide oligomer has a structure represented by Formula I-2:

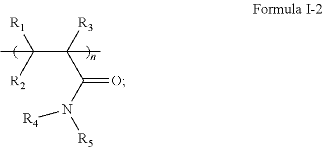

in Formula I-2, R₁ and R₂ are each independently hydrogen, fluorine, chlorine, or bromine; R₃ is hydrogen, methyl, hydroxymethyl, ethyl, hydroxyethyl, fluorine, chlorine, or bromine; R₄ and R₅ are each independently hydrogen, alkyl having 1 to 5 carbon atoms, phenyl, or acrylamido; n represents an integer from 2 to 10.

The crotonic acid monomer has a structure represented by Formula II-1:

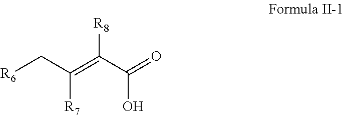

in Formula II-1, R₆ is hydrogen, hydroxyl, fluorine, chlorine, or bromine; R₇ and R₅ are each independently hydrogen, methyl, hydroxymethyl, fluorine, chlorine, or bromine.

The crotonic acid oligomer has a structure represented by Formula II-2:

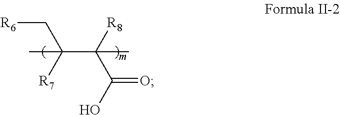

in Formula II-2, R₆ is hydrogen, hydroxyl, fluorine, chlorine, or bromine; R₇ and R₅ are each independently hydrogen, methyl, hydroxymethyl, fluorine, chlorine, or bromine; m represents an integer from 2 to 10.

The composite current collector provided by the present application is provided with a modified layer between the polymer base film and the metal layer, and polar functional groups such as carbonyl, amino, carboxyl, fluorine, chlorine, or bromine contained in the polymer contained in the modified layer can make the modified layer have high polarity and easily interact with metal atoms, thereby improving the bonding between the modified layer and the metal layer. In addition, by activating the polymer base film and the polymerization monomer and/or the oligomer using a photosensitizer and inducing a polymerization reaction under the joint action of the photosensitizer and ultraviolet light, the chemical bonds between the polymer base film and the modified layer are connected to each other, thereby ultimately effectively improving the bonding between the modified layer and the polymer base film. The reaction process (with the acrylamide monomer as an example) may be schematically represented as Formula (1). The polymer base film and the acrylamide monomer are activated by the photosensitizer. At the same time, under the joint action of the photosensitizer and ultraviolet light, the acrylamide monomer undergoes a graft polymerization reaction with the polymer base film, and the bonding to the polymer base film can be improved through such a chemical bond connection. Therefore, by providing the modified layer, the bonding between the modified layer and the metal layer and between the modified layer and the polymer base film can be increased simultaneously, thereby enhancing the structural stability of the composite current collector overall.

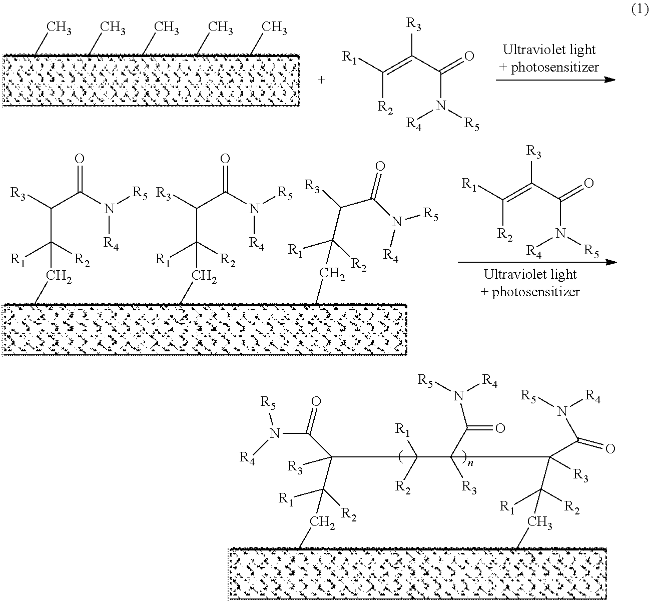

In some embodiments, the modified layer comprises a homopolymer of the crotonic acid monomer. Optionally, the polycrotonic acid may comprise polycrotonic acid, poly(4-hydroxycrotonic acid), poly(2-hydroxymethylcrotonic acid), poly(2,3-dihydroxymethylcrotonic acid), poly(3-chlorocrotonic acid), poly(3-chloro-4-hydroxycrotonic acid), poly(3,4-dichlorocrotonic acid), poly(2,3-dichloro-4-hydroxycrotonic acid), poly(2,3,4-trichlorocrotonic acid), poly(4-bromocrotonic acid), poly(4-fluorocrotonic acid) or a combination thereof.

In some embodiments, the polymer of the modified layer comprises a homopolymer of the acrylamide monomer. Optionally, the polyacrylamide may comprise polyacrylamide, polymethacrylamide, poly(N,N-methylenebisacrylamide), poly(N,N-dimethylacrylamide), poly(N-isopropylacrylamide), poly(N-tert-butylacrylamide), poly(N-phenylacrylamide), poly(2-chloro-acrylamide), poly(2-hydroxymethyl-acrylamide), poly(3-bromo-acrylamide), poly(2-hydroxymethyl-3-bromo-acrylamide) or a combination thereof.

In some embodiments, the polymer of the modified layer comprises a polyacrylamide-polyacrylamide copolymer formed from different acrylamide monomers. For example, the polymer of the modified layer may be formed from different monomers of Formula I-1.

In some embodiments, the polymer of the modified layer comprises a polycrotonic acid-polyacrylamide copolymer formed from the polyacrylamide monomer and the crotonic acid monomer. For example, the polymer of the modified layer may be formed from an oligomer of Formula I-2 and a monomer of Formula II-1, a monomer of Formula I-1 and an oligomer of Formula II-2, or a monomer of Formula I-1 and a monomer of Formula II-1, or an oligomer of Formula I-2 and an oligomer of Formula II-2, which is not described in detail herein.

In some embodiments, the polymer of the modified layer comprises a polycrotonic acid copolymer formed from different crotonic acid monomers. For example, the polymer of the modified layer may be formed from different monomers of Formula II-1.

In some embodiments, the modified layer comprises a homopolymer of the crotonic acid oligomer. Optionally, the polycrotonic acid may comprise polycrotonic acid, poly(4-hydroxycrotonic acid), poly(2-hydroxymethylcrotonic acid), poly(2,3-dihydroxymethylcrotonic acid), poly(3-chlorocrotonic acid), poly(3-chloro-4-hydroxycrotonic acid), poly(3,4-dichlorocrotonic acid), poly(2,3-dichloro-4-hydroxycrotonic acid), poly(2,3,4-trichlorocrotonic acid), poly(4-bromocrotonic acid), poly(4-fluorocrotonic acid) or a combination thereof.

In some embodiments, the polymer of the modified layer comprises a homopolymer of the acrylamide oligomer. Optionally, the polyacrylamide may comprise polyacrylamide, polymethacrylamide, poly(N,N-methylenebisacrylamide), poly(N,N-dimethylacrylamide), poly(N-isopropylacrylamide), poly(N-tert-butylacrylamide), poly(N-phenylacrylamide), poly(2-chloro-acrylamide), poly(2-hydroxymethyl-acrylamide), poly(3-bromo-acrylamide), poly(2-hydroxymethyl-3-bromo-acrylamide) or a combination thereof.

In some embodiments, the polymer of the modified layer comprises a polyacrylamide-polyacrylamide copolymer formed from different acrylamide oligomers. For example, the polymer of the modified layer may be formed from oligomers of Formula I-2 and Formula I-2.

In some embodiments, the polymer of the modified layer comprises a polycrotonic acid-polyacrylamide copolymer formed from the acrylamide oligomer and the crotonic acid monomer. For example, the polymer of the modified layer may be formed from an oligomer of Formula I-2 and a monomer of Formula II-1, which is not described in detail herein.

In some embodiments, the polymer of the modified layer comprises a polycrotonic acid copolymer formed from different crotonic acid oligomers. For example, the polymer of the modified layer may be formed from oligomers of Formula II-2 and Formula II-2.

In some embodiments, the polymer of the modified layer comprises a polyacrylamide-polyacrylamide copolymer formed from different polyacrylamide monomers and acrylamide oligomers.

In some embodiments, the polymer of the modified layer comprises a polycrotonic acid-polycrotonic acid copolymer formed from different crotonic acid monomers and crotonic acid oligomers.

In some embodiments, the polymer of the modified layer comprises a polycrotonic acid-polyacrylamide copolymer formed from the acrylamide oligomer and the crotonic acid monomer.

In some embodiments, the polymer of the modified layer comprises a polycrotonic acid-polyacrylamide copolymer formed from the acrylamide monomer and the crotonic acid oligomer.

In some embodiments, the modified layer has a thickness of 20 nm to 100 nm. For example, the thickness of the modified layer may be 30 nm, 40 nm, 50 nm, 60 nm, 70 nm, 80 nm or 90 nm or within a range consisting of any of the above values. The thickness of the modified layer is determined based on the consideration that the function of the modified layer is to improve the surface structure and properties of the polymer base film. Under the premise of achieving uniform modification, increasing the thickness of the modified layer cannot further enhance the surface structure and properties of the polymer base film, but instead would lead to increased raw material costs. Moreover, excessive thickness may potentially cause inhomogeneous modification issues. Therefore, the modified layer should not be overly thickened. By controlling the thickness of the modified layer within a suitable range, the modified layer can have a better bonding improvement effect, and inhomogeneous modification can be avoided.

In some embodiments, the polymer base film has a thickness of 2 μm to 20 μm. The thickness of the polymer base film is determined based on the application requirements of the composite current collector as well as the preparation process complexity and cost. Optionally, the polymer base film may be prepared by the melt-extrusion-biaxial stretching process.

In some embodiments, a material of the polymer base film may comprise polypropylene (PP), polyethylene (PE), polyethylene terephthalate (PET), polybutylene terephthalate (PBT), polyethylene naphthalate (PEN), polyphenelyne ether, polyvinyl chloride (PVC), polyvinylidene fluoride (PVDF), polytetrafluoroethylene (PTFE), polyphenylene sulfide (PPS), polyphenylene oxide (PPO), polystyrene (PS), polyimide (PI) or a combination thereof.

In some embodiments, the metal layer has a thickness of 500 nm to 2000 nm. Optionally, the thickness of the metal layer may be 700 nm to 1200 nm. By controlling the thickness of the metal layer within a suitable range, the composite current collector can have high conductivity.

It is to be understood that the metal layer may be provided on opposite sides of the polymer base film. The thicknesses of the metal layers on both sides may be the same or different, and the specific method for providing the metal layers may be selected according to the actual requirements.

In some embodiments, the method for preparing the metal layer is not particularly limited and may be selected according to actual requirements. For example, the metal layer may be prepared by physical vapor deposition (such as resistive heating vacuum evaporation, electron-beam heating vacuum evaporation, laser heating vacuum evaporation or magnetron sputtering, etc.), electroplating, electroless plating or the like.

In some embodiments, the material of the metal layer is not particularly limited and may be selected according to actual requirements. For example, the material of the metal layer may comprise copper, a copper alloy, aluminum, an aluminum alloy, nickel, a nickel alloy, titanium, silver or a combination thereof.

In some embodiments, the composite current collector may further comprise a protective layer. The protective layer is arranged on the surface of a side, facing away from the modified layer, of the metal layer.

In some embodiments, the thickness of the protective layer may be 10 nm to 150 nm. The protective layer is primarily designed to protect the metal layer from chemical corrosion or physical damage. By controlling the thickness of the protective layer within a suitable range, an effective protective effect can be achieved without compromising the conductivity of the metal layer. Optionally, the thickness of the protective layer is 20 nm to 100 nm, thereby achieving high conductivity while ensuring the protective effect.

The material of the protective layer is not particularly limited in the present application and may be selected according to actual requirements. For example, the material of the protective layer may comprise nickel, chromium, a nickel-based alloy, a copper-based alloy, copper oxide, aluminum oxide, nickel oxide, chromium oxide, cobalt oxide, graphite, carbon black, acetylene black, ketjen black, a carbon nano/quantum dot, a carbon nanotube, a carbon nanofiber, graphene or a combination thereof.

It is to be understood that the protective layer may be provided on one side of the polymer base film or may be provided on opposite sides of the polymer base film. When the protective layer is provided on opposite sides of the polymer base film, the thicknesses of the protective layers on both sides may be the same or different, and the specific method for providing the protective layers may be selected according to the actual requirements.

A second aspect of the present application provides a preparation method for a composite current collector. The preparation method may comprise steps S10 and S20.

In S10, a light-induced graft polymerization surface modification treatment is performed on the surface of a polymer base film to form a modified layer, in which the light-induced graft polymerization surface modification treatment comprises: a polymerization monomer and/or an oligomer undergo a light-induced graft polymerization reaction in the presence of a photosensitizer to form a polymer, the polymerization monomer comprises an acrylamide monomer, a crotonic acid monomer or a combination thereof, and the oligomer comprises an acrylamide oligomer, a crotonic acid oligomer or a combination thereof.

The acrylamide monomer has a structure represented by Formula I-1:

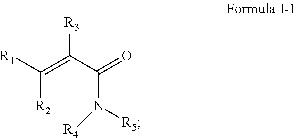

in Formula I-1, R₁ and R₂ are each independently hydrogen, fluorine, chlorine, or bromine; R₃ is hydrogen, methyl, hydroxymethyl, ethyl, hydroxyethyl, fluorine, chlorine, or bromine; R₄ and R₅ are each independently hydrogen, alkyl having 1 to 5 carbon atoms, phenyl, or acrylamido.

The acrylamide oligomer has a structure represented by Formula I-2:

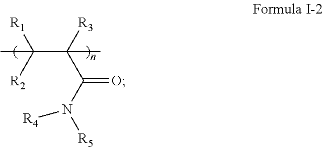

in Formula I-2, R₁ and R₂ are each independently hydrogen, fluorine, chlorine, or bromine; R₃ is hydrogen, methyl, hydroxymethyl, ethyl, hydroxyethyl, fluorine, chlorine, or bromine; R₄ and R₅ are each independently hydrogen, alkyl having 1 to 5 carbon atoms, phenyl, or acrylamido; n represents an integer from 2 to 10.

The crotonic acid monomer has a structure represented by Formula II-1:

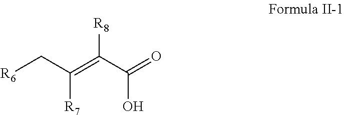

in Formula II-1, R₆ is hydrogen, hydroxyl, fluorine, chlorine, or bromine; R₇ and R₅ are each independently hydrogen, methyl, hydroxymethyl, fluorine, chlorine, or bromine.

The crotonic acid oligomer has a structure represented by Formula II-2:

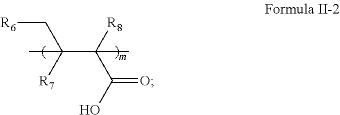

in Formula II-2, R₆ is hydrogen, hydroxyl, fluorine, chlorine, or bromine; R₇ and R₅ are each independently hydrogen, methyl, hydroxymethyl, fluorine, chlorine, or bromine; m represents an integer from 2 to 10.

In S20, a metal layer is formed on the surface of the modified layer.

In the present application, the modified layer may be prepared in situ on the surface of the polymer base film by light-induced graft polymerization. The polymer contained in the prepared modified layer contains polar functional groups such as carbonyl, amino, carboxyl, fluorine, chlorine, or bromine. These polar functional groups can make the modified layer have high polarity and easily interact with metal atoms, thereby improving the bonding between the modified layer and the metal layer. In addition, the modified layer is connected to the polymer base film through chemical bonds, thereby improving the bonding between the modified layer and the polymer base film.

In some embodiments, the step S10 may specifically comprise steps S110 and S120.

In S110, the polymer base film is immersed in a solution containing a photosensitizer, a polymerization monomer and/or an oligomer for pretreatment.

In S120, the polymer base film immersed in the solution is irradiated with an ultraviolet lamp in an inert atmosphere to cause a graft polymerization reaction on the surface of at least one side of the polymer base film under the induction of ultraviolet light to form the modified layer to obtain a composite film layer.

In some embodiments, the polymerization monomer may comprise an acrylamide monomer and/or a crotonic acid monomer.

It is to be understood that the polymerization monomer in the step S110 may be an acrylamide monomer, may be a crotonic acid monomer, or may contain both an acrylamide monomer and a crotonic acid monomer.

In some embodiments, the acrylamide monomer may comprise acrylamide, methacrylamide, N,N′-methylenebisacrylamide, N,N-dimethylacrylamide, N-isopropylacrylamide, N-tert-butylacrylamide, N-phenylacrylamide, 2-chloro-acrylamide, 2-hydroxymethyl-acrylamide, 3-bromo-acrylamide, 2-hydroxymethyl-3-bromo-acrylamide or a combination thereof.

In some embodiments, the crotonic acid monomer may comprise crotonic acid, 4-hydroxycrotonic acid, 2-hydroxymethylcrotonic acid, 2,3-dihydroxymethylcrotonic acid, 3-chlorocrotonic acid, 3-chloro-4-hydroxycrotonic acid, 3,4-dichlorocrotonic acid, 2,3-dichloro-4-hydroxycrotonic acid, 2,3,4-trichlorocrotonic acid, 4-bromocrotonic acid, 4-fluorocrotonic acid or a combination thereof.

In some embodiments, the oligomer may comprise an acrylamide oligomer and/or a crotonic acid oligomer.

In some embodiments, the acrylamide oligomer may comprise polyacrylamide, polymethacrylamide, poly(N,N-methylenebisacrylamide), poly(N,N-dimethylacrylamide), poly(N-isopropylacrylamide), poly(N-tert-butylacrylamide), poly(N-phenylacrylamide), poly(2-chloro-acrylamide), poly(2-hydroxymethyl-acrylamide), poly(3-bromo-acrylamide), poly(2-hydroxymethyl-3-bromo-acrylamide) or a combination thereof.

In some embodiments, the crotonic acid oligomer may comprise polycrotonic acid, poly(4-hydroxycrotonic acid), poly(2-hydroxymethylcrotonic acid), poly(2,3-dihydroxymethylcrotonic acid), poly(3-chlorocrotonic acid), poly(3-chloro-4-hydroxycrotonic acid), poly(3,4-dichlorocrotonic acid), poly(2,3-dichloro-4-hydroxycrotonic acid), poly(2,3,4-trichlorocrotonic acid), poly(4-bromocrotonic acid), poly(4-fluorocrotonic acid) or a combination thereof.

In some embodiments, the oligomer may comprise an acrylamide oligomer and/or a crotonic acid oligomer.

The acrylamide monomer, the crotonic acid monomer, the acrylamide oligomer or the crotonic acid oligomer provided by the present application has reactive activity and can achieve in-situ graft polymerization on the surface of the polymer base film under the induction of ultraviolet light. Specifically, under ultraviolet light, the photosensitizer activates the acrylamide monomer, the crotonic acid monomer, the acrylamide oligomer, the crotonic acid oligomer, and polymer base film macromolecules, and the C═C double bonds in the acrylamide monomer, the crotonic acid monomer, the acrylamide oligomer, and the crotonic acid oligomer undergo an addition reaction with the activated methyl C—H bonds in the polymer base film macromolecules to form a seed layer of the modified layer and generate chemical bonds capable of bonding to the polymer base film. Therefore, the modified layer is connected to the polymer base film through the chemical bonds, thereby improving the bonding between the modified layer and the polymer base film and enhancing the structural stability of the composite current collector.

Building upon the resulting seed layer, residual C—H bonds within the surface molecules of the seed layer are cleaved under the induction of ultraviolet light and subsequently react with newly introduced C═C double bonds from the acrylamide monomer, the crotonic acid monomer, the acrylamide oligomer, and the crotonic acid oligomer. With the above process repeatedly conducted, in-situ graft polymerization of acrylamide and crotonic acid reactive monomers is achieved on the surface of the polymer base film, thereby ultimately forming the desired modified layer.

In some embodiments, a concentration of the polymerization monomer and/or the oligomer in the solution containing the photosensitizer, the polymerization monomer and/or the oligomer is 0.5 mol/L to 1.3 mol/L. For example, the concentration of the polymerization monomer and/or the oligomer may be 0.6 mol/L, 0.7 mol/L, 0.8 mol/L, 0.9 mol/L, 1.0 mol/L, 1.1 mol/L or 1.2 mol/L or within a range consisting of any of the above values. In these embodiments, the uniformity of the formed modified layer can be further improved while ensuring the grafting effect.

If the concentration of the polymerization monomer and/or the oligomer is lower than the above range, the modification effect may not be sufficiently achieved; if the concentration exceeds the above range, the reaction may become excessively vigorous, and the uniformity of the modified layer may be compromised.

In some embodiments, the concentration of the photosensitizer in the solution containing the photosensitizer, the polymerization monomer and/or the oligomer is 0.1 mol/L to 0.3 mol/L. For example, the concentration of the photosensitizer may be 0.15 mol/L, 0.2 mol/L or 0.25 mol/L or within a range consisting of any of the above values. If the concentration of the photosensitizer is lower than the above range, the modification effect is insufficient; if the concentration exceeds the above range, the reaction becomes excessively vigorous, leading to poor uniformity of the modified layer.

In some embodiments, the photosensitizer may comprise a benzophenone photosensitizer. For example, the benzophenone photosensitizer may comprise benzophenone, 2,4-dihydroxybenzophenone, Michler's ketone or a combination thereof. The photosensitizer can absorb ultraviolet light, generate free radicals, and induce reactive monomers to react.

In some embodiments, the solvent contained in the solution containing the polymerization monomer and the photosensitizer may be a ketone solvent. For example, the solvent may comprise, but is not limited to, one or more of acetone, butanone, pentanone or the like.

It is to be noted that the light-induced graft polymerization reaction may be carried out in a light-induced graft polymerization device, and the device may comprise a gas supply unit, a pretreatment unit, a reaction unit, a cleaning unit, and the like.

In some embodiments, the gas supply unit may input nitrogen gas into the reaction apparatus to provide an inert gas protective atmosphere, thereby protecting free radical intermediates generated during the reaction.

In some embodiments, the reaction unit is mainly composed of upper and lower rows of ultraviolet lamps, and the distance between the ultraviolet lamps and the polymer base film may be 10 cm to 30 cm. If the distance between them is too long or too short, the intensity of ultraviolet light radiated to the surface of the polymer base film may be adversely affected, thereby resulting in a poor treatment effect.

In some embodiments, the ultraviolet lamp may be a high-pressure ultraviolet lamp, and the power density of the ultraviolet lamp is 50 W/cm to 250 W/cm. If the power density is lower than the above range, the reaction efficiency tends to become low, thereby resulting in a poor modification effect; if the power density exceeds the above range, the reaction rate becomes too fast, thereby resulting in non-uniform reactivity.

In some embodiments, the irradiation time of the ultraviolet lamp is 10 seconds to 200 seconds. If the irradiation time is too short, the modification effect becomes poor; if the irradiation time is too long, the modification tends to become non-uniform, thereby resulting in a poor modification effect.

In some embodiments, after the composite film layer is obtained, the step S10 may further comprise the step S130.

In S130, a cleaning treatment and a drying treatment are performed on the composite film layer.

In the step S130, the composite film layer may be placed into the cleaning unit, and optionally, the cleaning unit may be a hot water cleaning tank.

In some embodiments, the cleaning treatment may be performed at a temperature of 70° C. to 90° C.

In some embodiments, the cleaning treatment may be performed for 5 minutes to 10 minutes.

In the step S130, the cleaned composite film layer may be placed into an oven to perform the drying treatment.

In some embodiments, the drying treatment may be performed at a temperature of 60° C. to 80° C.

In some embodiments, the preparation method may further comprise the step S30.

In S30, a protective layer is formed on the surface of a side, facing away from the modified layer, of the metal layer.

In some embodiments, the method for preparing the protective layer is not particularly limited and may be selected according to actual requirements. For example, the protective layer may be prepared by one or more of physical vapor deposition, chemical vapor deposition, in-situ forming, coating or the like. The physical vapor deposition is preferably vacuum evaporation and magnetron sputtering; the chemical vapor deposition is preferably atmospheric pressure chemical vapor deposition and plasma-enhanced chemical vapor deposition; the in-situ forming is preferably a method of forming a metal oxide passivation layer in situ on the surface of the metal layer; the coating method is preferably die coating, blade coating or extrusion coating.

A third aspect of the present application provides an electrode. The electrode comprises the composite current collector described in the first aspect of the present application or a composite current collector prepared by the preparation method described in the second aspect of the present application.

In some embodiments, the electrode comprises a positive electrode and/or a negative electrode.

A fourth aspect of the present application provides a secondary battery. The secondary battery comprises the electrode described in the third aspect of the present application.

In some embodiments, the secondary battery may comprise a lithium-ion secondary battery or a sodium-ion secondary battery.

In some embodiments, the secondary battery comprises a positive electrode, a negative electrode, an electrolyte, and a separator. During battery charge-discharge cycles, active ions undergo reversible intercalation/deintercalation processes between the positive electrode and the negative electrode. The electrolyte functions to conduct ions between the positive electrode and the negative electrode. The separator is arranged between the positive electrode and the negative electrode and primarily functions to prevent electrode short-circuiting while allowing passage of ions.

A fifth aspect of the present disclosure provides an electrical device. The electrical device comprises the secondary battery described in the fourth aspect of the present application. The secondary battery may be used as a power source of the electrical device or may be used as an energy storage unit of the electrical device. The electrical device may be, but is not limited to, a mobile device, an electric vehicle, an electric train, a ship, a satellite, an energy storage system, and the like. For example, the electrical device may be a notebook computer, a pen input computer, a mobile computer, an electronic book player, a portable telephone, a portable facsimile machine, a portable copier, a portable printer, a head-mounted stereo headset, a video recorder, a liquid crystal television, a portable cleaner, a portable compact disc (CD) player, a mini CD, a transceiver, an electronic notepad, a calculator, a memory card, a portable audio recorder, a radio, a backup power supply, an electric motor, an automobile, a motorcycle, an electric bicycle, a bicycle, a lighting appliance, a toy, a game machine, a clock, a power tool, a flash, a camera, a large household battery, and the like.

### EXAMPLE

The following are specific examples, which more specifically describe the disclosure of the present application. These examples are for illustrative purposes only, since various modifications and variations within the scope of the disclosure of the present application will be apparent to those skilled in the art. Unless otherwise stated, all parts, percentages, and ratios reported in the examples below are on a weight basis, all reagents used in the examples are commercially available or synthetically obtained according to conventional methods and can be used directly without further processing, and the instruments used in the examples are commercially available.

### Example 1

### Preparation of Composite Current Collector

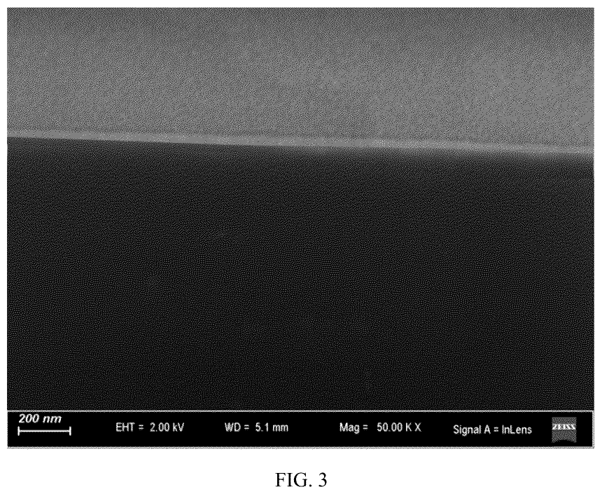

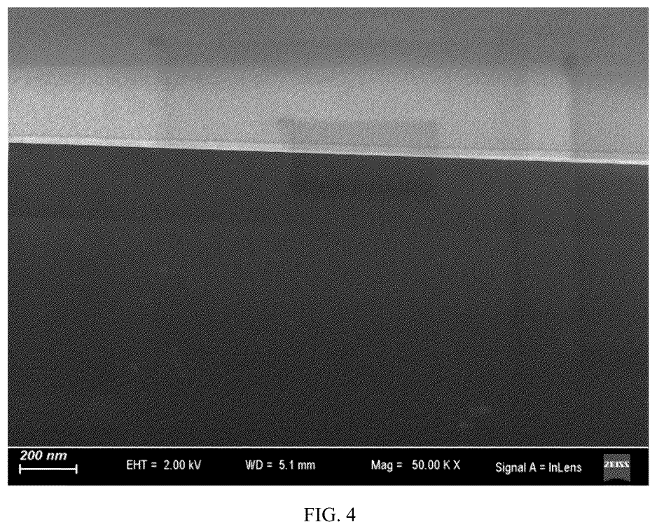

Preparation of a modified layer: An acetone solution containing 0.5 mol/L acrylamide and 0.1 mol/L benzophenone was prepared and poured into the tank of the pretreatment unit. Then, a commercially available biaxially-oriented polypropylene base film (manufacturer: Toray Industries, Japan, with a thickness of 4.5 μm) was placed into a light-induced graft polymerization device, and the gas inlet valve of the gas inlet unit was switched on to introduce nitrogen gas into the device. After the device was filled with nitrogen gas, the polypropylene base film was placed into the solution in the tank of the pretreatment unit and dip-coated for 30 seconds. After the dip coating was completed, the ultraviolet lamp in the reaction unit was turned on, and the polypropylene base film was placed into the reaction unit and irradiated for 10 seconds, where the distance between the polypropylene base film and the ultraviolet lamp was 10 cm, and the power density of the ultraviolet lamp was 50 W/cm. After the irradiation treatment was completed, the polypropylene base film was placed into the cleaning unit from the reaction unit and cleaned in pure water at 80° C. for 5 minutes. After the cleaning treatment was completed, the polypropylene base film was placed into an oven at 70° C. and dried to obtain a polypropylene film containing a modified layer on its surface. The cross-sectional morphology of the polypropylene modified film and the polypropylene modified film undergoing an enhanced surface cleaning treatment was characterized by field emission scanning electron microscopy (FESEM) to indirectly prove that polyacrylamide was grafted on the surface of the polypropylene film. The conditions for the enhanced surface cleaning treatment were: stirring in hot water at 80° C. and soaking for 48 hours. Since polyacrylamide is dissoluble in hot water, if polyacrylamide is not grafted onto the surface of the polypropylene film, the modified layer on the surface of the polypropylene film would dissolve after the enhanced surface cleaning treatment. The specific results are shown in FIGS. 3 and 4. As can be seen, after the enhanced surface cleaning treatment, the modified layer still existed, and the thickness of the polypropylene film basically remained unchanged, thereby proving that the modified layer was grafted onto the surface of the polypropylene film.

Preparation of a metal layer: The prepared polypropylene film containing the modified layer on its surface was placed into a vacuum evaporation chamber, a high-purity copper wire (purity >99.99%) in the metal evaporation chamber was melted and vaporized at a high temperature of 1500° C., and the vaporized metal atoms were deposited on both surfaces of the polymer base film by means of the cooling system in the vacuum coating chamber to form a copper conductive layer with a thickness of 1 micrometer.

Preparation of a protective layer: 1 g of graphene was uniformly dispersed into 999 g of N-methyl-2-pyrrolidone (NMP) solution by ultrasonic dispersion to prepare a coating solution with a solid content of 0.1 wt. %, and then the coating solution was uniformly coated onto the surface of the metal conductive layer by die coating, with the coated layer controlled at 80 microns, and finally dried at 75° C.

### Example 2

A composite current collector was prepared according to the method in Example 1 except that the concentration of acrylamide in the solution was adjusted to 0.9 mol/L during the preparation of the modified layer.

### Example 3

A composite current collector was prepared according to the method in Example 1 except that the concentration of acrylamide in the solution was 1.3 mol/L during the preparation of the modified layer.

### Example 4

A composite current collector was prepared according to the method in Example 2 except that the concentration of benzophenone in the solution was adjusted to 0.2 mol/L during the preparation of the modified layer.

### Example 5

A composite current collector was prepared according to the method in Example 2 except that the concentration of benzophenone in the solution was adjusted to 0.3 mol/L during the preparation of the modified layer.

### Example 6

A composite current collector was prepared according to the method in Example 4 except that the distance between the base film and the ultraviolet lamp was adjusted to 20 cm during the preparation of the modified layer.

### Example 7

A composite current collector was prepared according to the method in Example 4 except that the distance between the base film and the ultraviolet lamp was adjusted to 30 cm during the preparation of the modified layer.

### Example 8

A composite current collector was prepared according to the method in Example 6 except that the power density of the ultraviolet lamp was adjusted to 150 W/cm during the preparation of the modified layer.

### Example 9

A composite current collector was prepared according to the method in Example 6 except that the power density of the ultraviolet lamp was adjusted to 250 W/cm during the preparation of the modified layer.

### Example 10

A composite current collector was prepared according to the method in Example 8 except that the time of the irradiation treatment was adjusted to 100 seconds during the preparation of the modified layer.

### Example 11

A composite current collector was prepared according to the method in Example 8 except that the time of the irradiation treatment was adjusted to 200 seconds during the preparation of the modified layer.

### Example 12

A composite current collector was prepared according to the method in Example 10 except that benzophenone was replaced with 2,4-dihydroxybenzophenone during the preparation of the modified layer.

### Example 13

A composite current collector was prepared according to the method in Example 10 except that acrylamide was replaced with N,N′-methylenebisacrylamide during the preparation of the modified layer.

### Example 14

A composite current collector was prepared according to the method in Example 10 except that acrylamide was replaced with crotonic acid during the preparation of the modified layer.

### Example 15

A composite current collector was prepared according to the method in Example 10 except that acrylamide was replaced with 4-hydroxycrotonic acid during the preparation of the modified layer.

### Example 16

A composite current collector was prepared according to the method in Example 10 except that acrylamide was replaced with mixed monomers of acrylamide and 4-hydroxycrotonic acid during the preparation of the modified layer.

### Comparative Example 1

A composite current collector was prepared according to the method in Example 1 except that the polypropylene film did not undergo surface modification during the preparation of the modified layer.

### Comparative Example 2

The method in Comparative Example 2 was basically the same as the method in Example 1 except that during the preparation of the modified layer, the acrylamide solution in the tank of the pretreatment unit was dip-coated and the subsequent ultraviolet irradiation treatment was not performed.

### Comparative Example 3

The method in Comparative Example 3 was basically the same as the method in Example 1 except that during the preparation of the modified layer, the acrylamide solution in the tank of the pretreatment unit was replaced with a polyacrylamide solution and the subsequent ultraviolet irradiation treatment and cleaning treatment were not performed.

### Comparative Example 4

### Preparation of Composite Current Collector

Corona treatment: A polypropylene film was placed into a roll-to-roll corona treatment device, and with the corona power selected to 10 KW and the current selected to 6 A, the surface of the polypropylene film was treated at a linear speed of 100 m/min.

Preparation of a metal layer: The polypropylene film prepared after the corona treatment was placed into a vacuum evaporation chamber, a high-purity copper wire (purity >99.99%) in the metal evaporation chamber was melted and vaporized at a high temperature of 1500° C., and the vaporized metal atoms were deposited on both surfaces of the polymer base film by means of the cooling system in the vacuum coating chamber to form a copper conductive layer with a thickness of 1 micrometer.

Preparation of a protective layer: 1 g of graphene was uniformly dispersed into 999 g of N-methyl-2-pyrrolidone (NMP) solution by ultrasonic dispersion to prepare a coating solution with a solid content of 0.1 wt. %, and then the coating solution was uniformly coated onto the surface of the metal conductive layer by die coating, with the coated layer controlled at 80 microns, and finally dried at 75° C.

### Comparative Example 5

### Preparation of Composite Current Collector

Preparation of a polyacrylic acid modified layer: An aqueous solution containing 0.9 mol/L acrylic acid was prepared and poured into the tank of the pretreatment unit. Then, a commercially available biaxially-oriented polypropylene base film (manufacturer: Toray Industries, Japan, with a thickness of 4.5 μm) was placed into a light-induced graft polymerization device, and the gas inlet valve of the gas inlet unit was switched on to introduce nitrogen gas into the device. After the device was filled with nitrogen gas, the polypropylene base film was placed into the solution in the tank of the pretreatment unit and dip-coated for 30 seconds. After the dip coating was completed, the ultraviolet lamp in the reaction unit was turned on, and the polypropylene base film was placed into the reaction unit and irradiated for 100 seconds, where the distance between the polypropylene base film and the ultraviolet lamp was 20 cm, and the power density of the ultraviolet lamp was 150 W/cm. After the irradiation treatment was completed, the polypropylene base film was placed into the cleaning unit from the reaction unit and cleaned in pure water at 80° C. for 5 minutes. After the cleaning treatment was completed, the polypropylene base film was placed into an oven at 70° C. and dried to obtain a polypropylene film containing a modified layer on its surface.

Preparation of a metal layer: The prepared polypropylene film containing the modified layer on its surface was placed into a vacuum evaporation chamber, a high-purity copper wire (purity >99.99%) in the metal evaporation chamber was melted and vaporized at a high temperature of 1500° C., and the vaporized metal atoms were deposited on both surfaces of the polymer base film by means of the cooling system in the vacuum coating chamber to form a copper conductive layer with a thickness of 1 micrometer.

Preparation of a protective layer: 1 g of graphene was uniformly dispersed into 999 g of N-methyl-2-pyrrolidone (NMP) solution by ultrasonic dispersion to prepare a coating solution with a solid content of 0.1 wt. %, and then the coating solution was uniformly coated onto the surface of the metal conductive layer by die coating, with the coated layer controlled at 80 microns, and finally dried at 75° C.

The composite current collectors prepared in Examples 1 to 16 and Comparative Examples 1 to 5 underwent relevant property tests. The bonding between the base film and the metal layer serves as a critical indicator reflecting the structural stability of the composite current collector and thus was specifically measured herein. The enhancement of bonding depends on the surface tension of the modified layer on the surface of the base film. Accordingly, the surface tensions of the polypropylene modified films were measured. The storage stability of the polypropylene modified films was also validated by monitoring surface tension variations after three-month storage, and then the polypropylene modified films were compared with the conventional polypropylene film undergoing the corona treatment (known for storage instability). Furthermore, the thicknesses of the modified layers were measured to confirm the formation of the modified layers on the surfaces of the base films and analyze the effects of process conditions on the thicknesses of the modified layers. The test results are summarized in Table 1, where “/” denotes unavailable data for specific properties.

### Test

(1) Bonding: A layer of Permacel P-94 double-sided adhesive tape was bonded onto a 1 mm thick aluminum foil, a composite current collector sample was then bonded onto the double-sided adhesive tape, and a layer of ethylene-acrylic acid copolymer film (Dupont™ Nurcel™ 0903, with a thickness of 50 μm) was overlaid on the top of the sample. This multilayered structure was hot pressed at 1.3×10⁵ N/m2 and 120° C. for 10 seconds, cooled to room temperature, and precision-cut into 150 mm×15 mm strips. The ethylene-acrylic acid copolymer film of each sample strip was secured in the upper grip of the tensile testing machine while the remaining portion was clamped in the lower grip. Peel testing was subsequently performed at a 180° peeling angle and at a speed of 100 mm/min to measure the peel force, that is, to measure the bonding between the base film and the metal layer in the composite current collector.
(2) The initial surface tensions of the surface-modified base films and the surface tensions of the surface-modified base films after three-month storage were measured in accordance with GB/T14216-2008.
(3) Modified layer thickness: First, a surface-modified sample was placed into an argon ion milling system (Fischione 1061) and cut using an argon ion beam (~1 mm). After cutting, the sample then underwent gold spraying to obtain the cross-sectional surface of the sample. Subsequently, the resulting sample having a cross-sectional surface was mounted on a field emission scanning electron microscope (Zeiss Gemini Sigma 300/VP SEM) for morphological observation at 50,000× magnification, with optimized focus adjustments to capture a high-resolution cross-sectional image. Finally, the thickness of the modified layer in the obtained morphology image was annotated and quantified by using the measurement software integrated into the scanning electron microscope to obtain the thickness data of the modified layer.

TABLE 1

| | Surface-modified polymer base film | | | Composite current |
|---|---|---|---|---|
| | | Surface | | collector |
| | Initial | tension | Modified | Bonding between |
| | surface | after three- | layer | the base film and |
| | tension | month storage | thickness | the metal layer |
| No. | (mN/m) | (mN/m) | (nm) | (N/cm) |
| Example 1 | 41 | 40 | 20 | 1.1 |
| Example 2 | 44 | 45 | 29 | 1.3 |
| Example 3 | 43 | 43 | 36 | 1.2 |
| Example 4 | 47 | 47 | 40 | 1.6 |
| Example 5 | 45 | 46 | 43 | 1.4 |
| Example 6 | 56 | 55 | 50 | 2.0 |
| Example 7 | 46 | 45 | 46 | 1.5 |
| Example 8 | 63 | 62 | 64 | 2.4 |
| Example 9 | 59 | 59 | 79 | 2.2 |
| Example 10 | 67 | 66 | 90 | 2.6 |
| Example 11 | 57 | 58 | 100 | 2.1 |
| Example 12 | 64 | 63 | 85 | 2.5 |
| Example 13 | 65 | 65 | 88 | 2.5 |
| Example 14 | 68 | 67 | 83 | 2.8 |
| Example 15 | 69 | 70 | 80 | 3.0 |
| Example 16 | 70 | 70 | 81 | 3.0 |
| Comparative | 30 | 30 | / | 0.5 |
| Example 1 | | | | |
| Comparative | 30 | 30 | / | 0.5 |
| Example 2 | | | | |
| Comparative | 55 | 53 | 90 | 0.8 |
| Example 3 | | | | |
| Comparative | 40 | 32 | / | 1.0 |
| Example 4 | | | | |
| Comparative | 65 | 57 | 71 | 1.0 |
| Example 5 | | | | |

As can be seen from the comparison between Examples 1 to 16 and Comparative Examples 1 to 3, compared with the operation of not performing surface modification on the base film, performing the surface modification treatment on the base film by using the method provided by the present application can significantly improve the bonding between the base film and the metal layer of the prepared composite current collector.

As can be seen from the comparison between Example 1 and Comparative Example 2, the polypropylene base film in Comparative Example 2 is directly dip-coated with the acrylamide solution in the tank of the pretreatment unit and does not undergo the ultraviolet irradiation treatment, and the surface tension of the prepared polypropylene modified base film is low, which is equivalent to the surface tension of the polypropylene unmodified film in Comparative Example 1; this is because when the polypropylene base film is only dip-coated with the acrylamide solution in the tank of the pretreatment unit without the ultraviolet irradiation treatment, the acrylamide cannot be grafted onto the surface of the polypropylene base film and cannot undergo a self-polymerization reaction, and the acrylamide monomers coated on the surface of the polypropylene film is cleaned away in the cleaning unit, so no modified layer is formed on the surface of the polypropylene film; the polypropylene film in Example 1 undergoes the ultraviolet irradiation treatment so that a modified layer is formed on the surface of the polypropylene film, and the modified layer effectively improves the stability of the surface tension of the polymer base film.

As can be seen from the comparison between Example 1 and Comparative Example 3, the polypropylene base film in Comparative Example 3 is directly dip-coated with the polyacrylamide solution in the tank of the pretreatment unit and does not undergo the ultraviolet irradiation treatment, and although the surface tension of the prepared polypropylene modified base film is improved, the bonding between the polyacrylamide modified layer and the polypropylene film is low because no grafting reaction occurs between them, thereby resulting in low bonding between the polymer base film and the metal layer of the prepared composite current collector, that is, the modified layer fails to improve the bonding between the polymer base film and the metal layer; the polyacrylamide modified layer in Example 1 undergoes a grafting reaction with the polypropylene film, and thus the bonding between the two is improved, thereby improving the bonding between the polymer base film and the metal layer in the composite current collector.

As can be seen from the comparison between Example 1 and Comparative Example 4, compared with the polypropylene film prepared by the conventional corona modification treatment, the polymer modified base film prepared by using the method provided by the present application has stable surface tension (the surface tension of the surface-modified polymer base film after three-month storage is basically unchanged), that is, the polymer modified base film can still be used to prepare the composite current collector even after being stored for a period of time, which is the advantage the conventional corona method does not have. In addition, the bonding between the base film and the metal layer of the composite current collector prepared by using the method provided by the present application is superior, that is, the structure of the composite current collector is more stable. Finally, it is to be noted that the bonding between the base film and the metal layer mainly depends on the surface properties and structure of the modified layer. On the premise that the modified layer is uniform, the bonding has nothing to do with the thickness of the modified layer but mainly depends on the surface properties, that is, the magnitude of surface tension.

As can be seen from the comparison between Example 14 and Comparative Example 5, compared with the polyacrylic acid modified film formed by directly coating polyacrylic acid on the surface of the polypropylene film and carrying out in-situ polymerization, the polymer modified base film prepared by using the method provided by the present application has more stable surface tension (the surface tension of the surface-modified polymer base film after three-month storage is basically unchanged), the bonding between the base film and the metal layer of the composite current collector is larger, and the structure of the composite current collector is more stable. This is because in Comparative Example 5, no in-situ graft polymerization reaction occurs, only self-polymerization of acrylic acid monomers occurs to generate polyacrylic acid, and the polyacrylic acid does not react with the polymer base film to form any chemical bond, so the bonding between the polymer base film and the polyacrylic acid modified layer in Comparative Example 5 is lower than the bonding between the polycrotonic acid modified layer and the polypropylene film in Example 14, thereby resulting in a reduction in the bonding between the polymer base film and the metal layer in the composite current collector. In addition, since the molecular weight of the polycrotonic acid in the polymer film modified layer prepared in Example 14 is higher than the molecular weight of the polycrotonic acid in the polymer film modified layer prepared in Comparative Example 5, the structural stability of the polymer film modified layer prepared in Example 14 is higher, and thus the surface tension variation of the polymer modified film prepared in the present application is smaller during storage.

The technical features of the preceding embodiments may be combined in any manner. For brevity of description, not all possible combinations of the technical features in the preceding embodiments are described. However, as long as no conflict exists between the combinations of these technical features, such combinations are to be construed as being within the scope of the specification.

The preceding embodiments are only for the purpose of illustrating several implementation modes of the present application. Although these embodiments are described specifically and in detail, they should not be construed as limitations on the scope of the present application. It is to be noted that those of ordinary skill in the art can make a number of variations and improvements without departing from the concept of the present application, and such variations and improvements are within the scope of the present application. Therefore, the scope of the present application is intended to be defined by the claims.

1. A composite current collector, comprising a polymer base film and composite layers arranged on two sides of the polymer base film; wherein each of the composite layers comprises: a modified layer arranged on the polymer base film and a metal layer arranged on a surface of the modified layer, wherein a material of the modified layer comprises a polymer formed by in-situ graft polymerization of a polymerization monomer on a surface of the polymer base film, and the polymerization monomer comprises an acrylamide monomer, a crotonic acid monomer, an acrylamide oligomer, a crotonic acid oligomer or a combination thereof;
wherein the acrylamide monomer has a structure represented by Formula I-1: 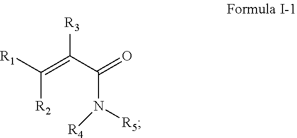
in Formula I-1, R₁ and R₂ are each independently hydrogen, fluorine, chlorine, or bromine; R₃ is hydrogen, methyl, hydroxymethyl, ethyl, hydroxyethyl, fluorine, chlorine, or bromine; R₄ and R₅ are each independently hydrogen, alkyl having 1 to 5 carbon atoms, phenyl, or acrylamido;
wherein the acrylamide oligomer has a structure represented by Formula I-2: 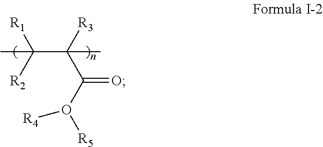
in Formula I-2, R₁ and R₂ are each independently hydrogen, fluorine, chlorine, or bromine; R₃ is hydrogen, methyl, hydroxymethyl, ethyl, hydroxyethyl, fluorine, chlorine, or bromine; R₄ and R₅ are each independently hydrogen, alkyl having 1 to 5 carbon atoms, phenyl, or acrylamido; n represents an integer from 2 to 10;
wherein the crotonic acid monomer has a structure represented by Formula II-1: 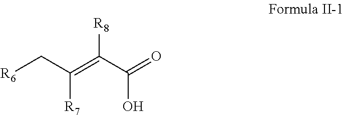
in Formula II-1, R₆ is hydrogen, hydroxyl, fluorine, chlorine, or bromine; R₇ and R₅ are each independently hydrogen, methyl, hydroxymethyl, fluorine, chlorine, or bromine;
wherein the crotonic acid oligomer has a structure represented by Formula II-2: 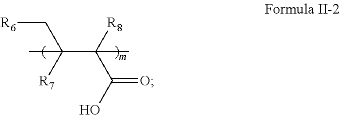
in Formula II-2, R₆ is hydrogen, hydroxyl, fluorine, chlorine, or bromine; R₇ and R₅ are each independently hydrogen, methyl, hydroxymethyl, fluorine, chlorine, or bromine; m represents an integer from 2 to 10.

2. The composite current collector according to claim 1, wherein the modified layer meets at least one of the following conditions:
(1) a polymer of the modified layer comprises a homopolymer of the crotonic acid monomer; optionally, the polymer is selected from polycrotonic acid, poly(4-hydroxycrotonic acid), poly(2-hydroxymethylcrotonic acid), poly(2,3-dihydroxymethylcrotonic acid), poly(3-chlorocrotonic acid), poly(3-chloro-4-hydroxycrotonic acid), poly(3,4-dichlorocrotonic acid), poly(2,3-dichloro-4-hydroxycrotonic acid), poly(2,3,4-trichlorocrotonic acid), poly(4-bromocrotonic acid), poly(4-fluorocrotonic acid), and combinations thereof;
(2) a polymer of the modified layer comprises a homopolymer of the acrylamide monomer; optionally, the polymer is selected from polyacrylamide, polymethacrylamide, poly(N,N-methylenebisacrylamide), poly(N,N-dimethylacrylamide), poly(N-isopropylacrylamide), poly(N-tert-butylacrylamide), poly(N-phenylacrylamide), poly(2-chloro-acrylamide), poly(2-hydroxymethyl-acrylamide), poly(3-bromo-acrylamide), poly(2-hydroxymethyl-3-bromo-acrylamide), and combinations thereof;
(3) a polymer of the modified layer comprises a polyacrylamide-polyacrylamide copolymer formed from different acrylamide monomers;
(4) a polymer of the modified layer comprises a polycrotonic acid-polycrotonic acid copolymer formed from different crotonic acid monomers;
(5) a polymer of the modified layer comprises a polycrotonic acid-polyacrylamide copolymer formed from the acrylamide monomer and the crotonic acid monomer;
(6) a polymer of the modified layer comprises a homopolymer of the crotonic acid oligomer; optionally, the polymer is selected from polycrotonic acid, poly(4-hydroxycrotonic acid), poly(2-hydroxymethylcrotonic acid), poly(2,3-dihydroxymethylcrotonic acid), poly(3-chlorocrotonic acid), poly(3-chloro-4-hydroxycrotonic acid), poly(3,4-dichlorocrotonic acid), poly(2,3-dichloro-4-hydroxycrotonic acid), poly(2,3,4-trichlorocrotonic acid), poly(4-bromocrotonic acid), poly(4-fluorocrotonic acid), and combinations thereof;
(7) a polymer of the modified layer comprises a homopolymer of the acrylamide oligomer; optionally, the polymer is selected from polyacrylamide, polymethacrylamide, poly(N,N-methylenebisacrylamide), poly(N,N-dimethylacrylamide), poly(N-isopropylacrylamide), poly(N-tert-butylacrylamide), poly(N-phenylacrylamide), poly(2-chloro-acrylamide), poly(2-hydroxymethyl-acrylamide), poly(3-bromo-acrylamide), poly(2-hydroxymethyl-3-bromo-acrylamide), and combinations thereof;
(8) a polymer of the modified layer comprises a polyacrylamide-polyacrylamide copolymer formed from different acrylamide oligomers;
(9) a polymer of the modified layer comprises a polycrotonic acid-polycrotonic acid copolymer formed from different crotonic acid oligomers;
(10) a polymer of the modified layer comprises a polycrotonic acid-polyacrylamide copolymer formed from the acrylamide oligomer and the crotonic acid oligomer;
(11) a polymer of the modified layer comprises a polyacrylamide-polyacrylamide copolymer formed from different acrylamide monomers and acrylamide oligomers;
(12) a polymer of the modified layer comprises a polycrotonic acid-polycrotonic acid copolymer formed from different crotonic acid monomers and crotonic acid oligomers;
(13) a polymer of the modified layer comprises a polycrotonic acid-polyacrylamide copolymer formed from the acrylamide oligomer and the crotonic acid monomer; and
(14) a polymer of the modified layer comprises a polycrotonic acid-polyacrylamide copolymer formed from the acrylamide monomer and the crotonic acid oligomer.

3. The composite current collector according to claim 1, wherein the composite current collector meets at least one of the following conditions:
(1) the modified layer has a thickness of 20 nm to 100 nm;
(2) the polymer base film has a thickness of 2 μm to 20 μm;
optionally, a material of the polymer base film comprises polypropylene, polyethylene, polyethylene terephthalate, polybutylene terephthalate, polyethylene naphthalate, polyphenelyne ether, polyvinyl chloride, polyvinylidene fluoride, polystyrene or a combination thereof; and
(3) the metal layer has a thickness of 500 nm to 2000 nm; optionally, a material of the metal layer comprises copper, a copper alloy, aluminum, an aluminum alloy, nickel, a nickel alloy, titanium, silver or a combination thereof.

4. The composite current collector according to claim 1, wherein the composite layer further comprises a protective layer, and the protective layer is arranged on a surface of a side, facing away from the modified layer, of the metal layer;
optionally, the protective layer has a thickness of 10 nm to 150 nm;
optionally, a material of the protective layer comprises nickel, chromium, a nickel-based alloy, a copper-based alloy, copper oxide, aluminum oxide, nickel oxide, chromium oxide, cobalt oxide, graphite, carbon black, acetylene black, ketjen black, a carbon nano/quantum dot, a carbon nanotube, a carbon nanofiber, graphene or a combination thereof.

5. A preparation method for a composite current collector, comprising:
performing a light-induced graft polymerization surface modification treatment on a surface of a polymer base film to form a modified layer; and
forming a metal layer on a surface of the modified layer;
wherein the light-induced graft polymerization surface modification treatment comprises: subjecting a polymerization monomer or an oligomer to a light-induced graft polymerization reaction in the presence of a photosensitizer to form a polymer;
wherein the polymerization monomer comprises an acrylamide monomer, a crotonic acid monomer, an acrylamide oligomer, a crotonic acid oligomer or a combination thereof;
wherein the acrylamide monomer has a structure represented by Formula I-1: 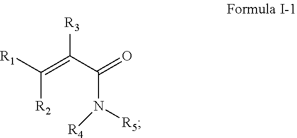
in Formula I-1, R₁ and R₂ are each independently hydrogen, fluorine, chlorine, or bromine; R₃ is hydrogen, methyl, hydroxymethyl, ethyl, hydroxyethyl, fluorine, chlorine, or bromine; R₄ and R₅ are each independently hydrogen, alkyl having 1 to 5 carbon atoms, phenyl, or acrylamido; n represents an integer from 2 to 10;
wherein the acrylamide oligomer has a structure represented by Formula I-2: 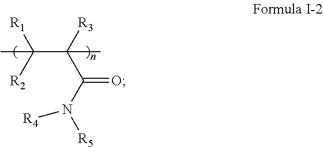
in Formula I-2, R₁ and R₂ are each independently hydrogen, fluorine, chlorine, or bromine; R₃ is hydrogen, methyl, hydroxymethyl, ethyl, hydroxyethyl, fluorine, chlorine, or bromine; R₄ and R₅ are each independently hydrogen, alkyl having 1 to 5 carbon atoms, phenyl, or acrylamido; n represents an integer from 2 to 10;
wherein the crotonic acid monomer has a structure represented by Formula II-1: 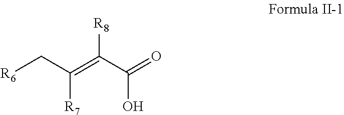
in Formula II-1, R₆ is hydrogen, hydroxyl, fluorine, chlorine, or bromine; R₇ and R₅ are each independently hydrogen, methyl, hydroxymethyl, fluorine, chlorine, or bromine;
wherein the crotonic acid oligomer has a structure represented by Formula II-2: 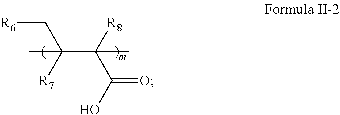
in Formula II-2, R₆ is hydrogen, hydroxyl, fluorine, chlorine, or bromine; R₇ and R₅ are each independently hydrogen, methyl, hydroxymethyl, fluorine, chlorine, or bromine; m represents an integer from 2 to 10.

6. The preparation method according to claim 5, wherein performing the light-induced graft polymerization surface modification treatment on the surface of the polymer base film comprises:
immersing the polymer base film in a solution containing a photosensitizer, a polymerization monomer and/or an oligomer for pretreatment; and
irradiating the polymer base film immersed in the solution with an ultraviolet lamp in an inert atmosphere to cause a graft polymerization reaction on the surface of the polymer base film under the induction of ultraviolet light to form the modified layer.

7. The preparation method according to claim 6, wherein the preparation method meets at least one of the following conditions:
(1) the polymerization monomer in the solution has a concentration of 0.5 mol/L to 1.3 mol/L;
(2) the photosensitizer in the solution has a concentration of 0.1 mol/L to 0.3 mol/L; and
(3) the photosensitizer comprises a benzophenone photosensitizer;
optionally, the benzophenone photosensitizer comprises benzophenone, 2,4-dihydroxybenzophenone, Michler's ketone or a combination thereof.

8. The preparation method according to claim 6, wherein the preparation method meets at least one of the following conditions:
(1) a distance between the ultraviolet lamp and the polymer base film is 10 cm to 30 cm;
(2) the ultraviolet lamp has a power density of 50 W/cm to 250 W/cm; and
(3) the ultraviolet lamp has an irradiation time of 10 seconds to 200 seconds.

9. The preparation method according to claim 5, wherein the preparation method meets at least one of the following conditions:
(1) the acrylamide monomer comprises acrylamide, methacrylamide, N,N′-methylenebisacrylamide, N,N-dimethylacrylamide, N-isopropylacrylamide, N-tert-butylacrylamide, N-phenylacrylamide, 2-chloro-acrylamide, 2-hydroxymethyl-acrylamide, 3-bromo-acrylamide, 2-hydroxymethyl-3-bromo-acrylamide or a combination thereof;
(2) the crotonic acid monomer comprises crotonic acid, 4-hydroxycrotonic acid, 2-hydroxymethylcrotonic acid, 2,3-dihydroxymethylcrotonic acid, 3-chlorocrotonic acid, 3-chloro-4-hydroxycrotonic acid, 3,4-dichlorocrotonic acid, 2,3-dichloro-4-hydroxycrotonic acid, 2,3,4-trichlorocrotonic acid, 4-bromocrotonic acid, 4-fluorocrotonic acid or a combination thereof;
(3) the crotonic acid oligomer comprises polycrotonic acid, poly(4-hydroxycrotonic acid), poly(2-hydroxymethylcrotonic acid), poly(2,3-dihydroxymethylcrotonic acid), poly(3-chlorocrotonic acid), poly(3-chloro-4-hydroxycrotonic acid), poly(3,4-dichlorocrotonic acid), poly(2,3-dichloro-4-hydroxycrotonic acid), poly(2,3,4-trichlorocrotonic acid), poly(4-bromocrotonic acid), poly(4-fluorocrotonic acid), and combinations thereof; and
(7) the acrylamide oligomer comprises polyacrylamide, polymethacrylamide, poly(N,N-methylenebisacrylamide), poly(N,N-dimethylacrylamide), poly(N-isopropylacrylamide), poly(N-tert-butylacrylamide), poly(N-phenylacrylamide), poly(2-chloro-acrylamide), poly(2-hydroxymethyl-acrylamide), poly(3-bromo-acrylamide), poly(2-hydroxymethyl-3-bromo-acrylamide), and combinations thereof.

10. The preparation method according to claim 5, wherein the preparation method meets at least one of the following conditions:
(1) the polymerization monomer is selected from one, two or more crotonic acid monomers;
(2) the polymerization monomer is selected from one, two or more acrylamide monomers;
(3) the polymerization monomer comprises the acrylamide monomer and the crotonic acid monomer;
(4) the polymerization monomer is selected from one, two or more crotonic acid oligomers;
(5) the polymerization monomer is selected from one, two or more acrylamide oligomers;
(6) the polymerization monomer comprises at least one acrylamide oligomer and at least one crotonic acid oligomer;
(7) the polymerization monomer comprises at least one acrylamide monomer and at least one crotonic acid oligomer; and
(8) the polymerization monomer comprises at least one acrylamide oligomer and at least one crotonic acid monomer.

11. The preparation method according to claim 5,
after forming the modified layer, further comprising:
performing a cleaning treatment and a drying treatment on the polymer base film containing the modified layer;
optionally, the cleaning treatment is performed at a temperature of 70° C. to 90° C.;
optionally, the cleaning treatment is performed for a period of 5 minutes to 10 minutes; and
optionally, the drying treatment is performed at a temperature of 60° C. to 80° C.

12. The preparation method according to claim 5,
further comprising:
forming a protective layer on a surface of a side, facing away from the modified layer, of the metal layer;
optionally, a material of the metal layer comprises copper, a copper alloy, aluminum, an aluminum alloy, nickel, a nickel alloy, titanium, silver or a combination thereof; and
optionally, a material of the protective layer comprises nickel, chromium, a nickel-based alloy, a copper-based alloy, copper oxide, aluminum oxide, nickel oxide, chromium oxide, cobalt oxide, graphite, carbon black, acetylene black, ketjen black, a carbon nano/quantum dot, a carbon nanotube, a carbon nanofiber, graphene or a combination thereof.

13. A composite current collector prepared by the preparation method according to claim 5.

14. An electrode, comprising the composite current collector according to claim 1.

15. A secondary battery, comprising the electrode according to claim 14.
